(19) United States
(12) Patent Application Publication
(10) Pub. No.: US 2007/0006690 A1
(43) Pub. Date: Jan. 11, 2007

(54) Cartridge removal and installation tool

(76) Inventor: Daniel Raymond Foster, Pflugerville, TX (US)

Correspondence Address: DICKE, BILLIG & CZAJA, P.L.L.C., FIFTH STREET TOWERS, 100 SOUTH FIFTH STREET, SUITE 2250, MINNEAPOLIS, MN, 55402, US

(21) Appl. No.: 11/481,333

(22) Filed: Jul. 5, 2006

Related U.S. Application Data
(60) Provisional application No. 60/696,907, filed on Jul. 6, 2005.

(51) Int. Cl. B25B 13/00

(52) U.S. Cl. 81/124.2

(57) ABSTRACT

A tool for removing and installing a flush valve cartridge of the type having a plurality of vane-like structures. The tool includes a hollow longitudinal body having side walls, a closed end and an open end. A drive engagement means is positioned at the closed end of the longitudinal body. A plurality of longitudinal slots extend through the sidewalls at the open end of the longitudinal body. The slots extend from the open end of the longitudinal body and terminate a distance from the open end. The slots are configured and positioned for engagement with the plurality of vane-like structures of the flush valve cartridge.

### FIELD OF THE INVENTION

The present invention generally relates to plumbing tools, and more particularly to a tool for removal and installation of flush valve cartridges in a pressure tank used in a common toilet.

### BACKGROUND

The issue of water conservation is a major concern for most municipalities, and toilets of the past are well-recognized as water wasters, sometimes requiring several gallons of water to complete a flush. Acknowledging the desirability of water conservation, many cities have modified their building codes in such a manner that all toilets installed during new construction must be of the so-called “low flush” variety. Low flush toilets are generally defined as toilets requiring 1.5 gallons of water per flush, or less.

Although the purpose of requiring low flush toilets is well intentioned, some low flush toilets do not provide the flushing force required to prevent persistent toilet clogging problems. One way that this problem is being address is to replace gravity-flow toilets with toilets having a pressure tank. The pressure tank stores the toilet's water under a pressure equal to the water supply line pressure. The pressure tank is provided with a high volume flow valve such that the water stored in the pressure tank is quickly released into the toilet bowl, thereby greatly increasing the flushing force of the toilet.

One available pressure tank is the Flushmate® Pressure-Assist system, sold by Sloan Valve Company of Franklin Park, IL. The Sloan Flushmate® system is comprised of two major components: 1) a pressure vessel shaped to fit within a conventional toilet tank; and 2) a flush valve (sometimes referred to herein as a “flush valve cartridge”, or simply “cartridge”) that is threaded into the upper surface of the pressure vessel. One exemplary flush valve cartridge is available as part number C-100500 from Sloan Valve Company. As with all mechanical devices, it is sometimes necessary to remove and replace the flush valve cartridge. The removal of the flush valve cartridge from the pressure vessel is sometimes very difficult, requiring excessive rotational force to break loose the connecting threads. In the case of the Sloan Valve Company Flushmate® system, the manufacturer's recommend method of cartridge removal is to use the handle end of an adjustable pair of pliers to transfer rotational force to molded vane-like features present on the body of the flush valve cartridge. Frequently, the force required to remove the flush valve cartridge from the pressure vessel exceeds the strength of the above-mentioned molded features, causing the molded features to break and thereby making removal of the flush valve cartridge even more difficult. Similarly, when installing a new cartridge, it is possible to apply excess force and break the cartridge. The present invention solves the flush valve cartridge removal and installation problem by providing an article that is unique in design and function thus prevents any unwanted damage.

### SUMMARY

In one aspect, the present invention provides a plumbing tool for the removal and installation of a flush valve cartridge of the type having a plurality of vane-like structures. In one embodiment, the tool comprises a hollow longitudinal body having side walls, a closed end and an open end. A drive engagement means is positioned at the closed end of the longitudinal body. A plurality of longitudinal slots extend through the sidewalls at the open end of the longitudinal body. The slots extend from the open end of the longitudinal body and terminate a distance from the open end. The slots are configured and positioned for engagement with the plurality of vane-like structures of the flush valve cartridge.

### BRIEF DESCRIPTION OF THE DRAWINGS

FIG. 1 is a perspective illustration of a toilet tank fitted with a water pressure vessel having a flush valve cartridge.

FIG. 2 is a perspective illustration of the flush valve cartridge of FIG. 1.

FIG. 3 is an exploded perspective view of the flush valve cartridge of FIG. 2.

FIG. 4 is illustrates a prior art method of removing or installing a flush valve cartridge with an adjustable pliers.

FIG. 5 is a perspective illustration of one embodiment of a cartridge removal/installation tool according to the invention.

FIG. 6 illustrates to cartridge removal/installation tool of FIG. 5 positioned for engagement with a ratchet.

FIG. 7 is a perspective illustration of another embodiment of a cartridge removal/installation tool according to the invention, positioned for engagement with a ratchet.

FIG. 8 is perspective illustration of the cartridge removal/installation tool of FIGS. 5 and 6, positioned for engagement with a cartridge.

FIG. 9 illustrates removing or installing a flush valve cartridge with the tool of the present invention.

### DETAILED DESCRIPTION

In the following Detailed Description, reference is made to the accompanying drawings, which form a part hereof, and in which is shown by way of illustration specific embodiments in which the invention may be practiced. In this regard, directional terminology, such as “top,” “bottom,” “front,” “back,” “leading,” “trailing,” etc., is used with reference to the orientation of the Figure(s) being described. Because components of embodiments of the present invention can be positioned in a number of different orientations, the directional terminology is used for purposes of illustration and is in no way limiting. It is to be understood that other embodiments may be utilized and structural or logical changes may be made without departing from the scope of the present invention. The following detailed description, therefore, is not to be taken in a limiting sense, and the scope of the present invention is defined by the appended claims.

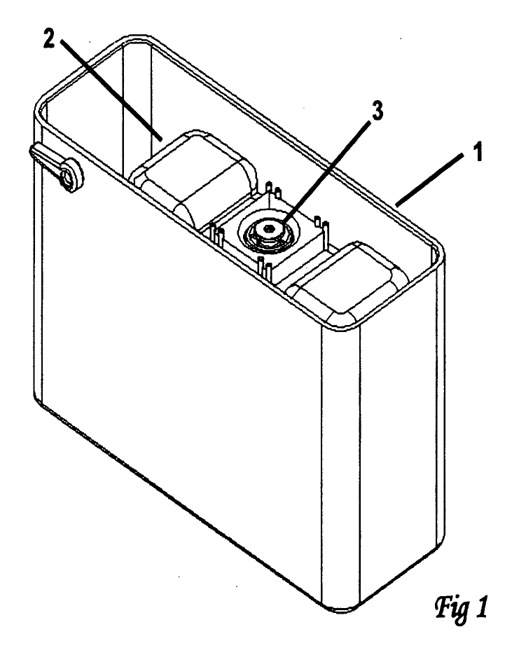

Referring to FIG. 1., a conventional toilet tank, generally identified by reference numeral (1), is fitted with a water pressure vessel (2) having installed therein a flush valve cartridge (3). Flush valve cartridge (3) is installed in pressure vessel (2) by threaded engagement between flush valve cartridge (3) and pressure vessel (2).

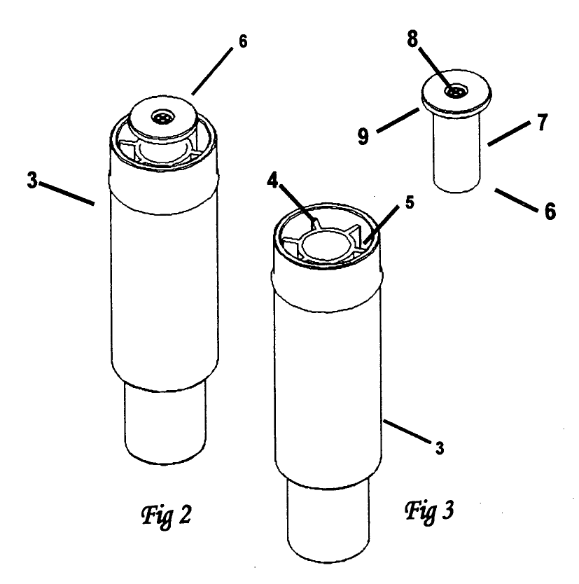

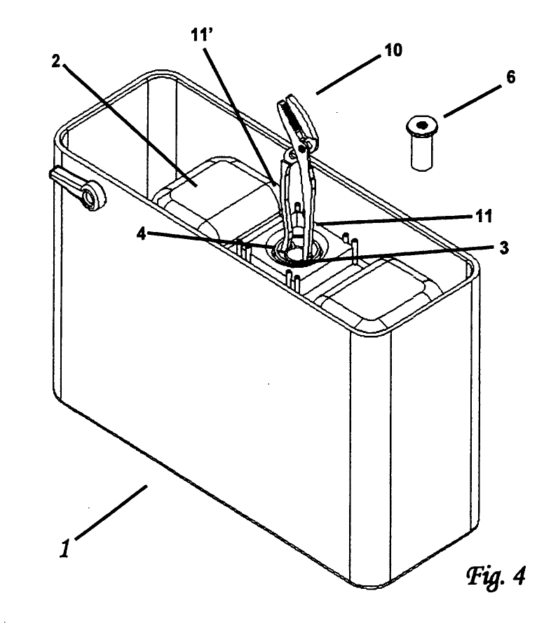

As better seen in FIGS. 2 and 3, the flush valve (3) includes an actuator (6). Actuator (6) is comprised of a cylinder (7) attached to an upper cover section (9). Cover section (9) extends beyond the vertical sidewalls of cylinder (7). Actuator (6) is removably secured to flush valve cartridge (3) using screw (8) or similar connection means. The body of flush valve cartridge (3) is includes a plurality of vane-like structures (4) radiating from a centrally located hub section (5). In the illustrated embodiment, six vane-like structures (4) are illustrated, although other numbers of vane-like structures may be present. Generally, the flush valve cartridges (3) are molded from thermoplastic materials of fairly low structural strength, and the vane-like structures (4) are relatively thin and/or weak.

Heretofore, the removal of the flush valve cartridge (3) from pressure vessel (2) has been accompanied by a considerable amount of difficulty. The cartridge (3) to be removed may have been installed for a considerable length of time, resulting in the cartridge (3) becoming “frozen” or stuck in the pressure vessel (2), and thus requiring considerable force to remove. Also, the location of pressure vessel (2) being recessed within the toilet tank (1) (see FIG. 1) often limits access to flush valve cartridge (3). Frequently, there are shelves, assist bars, or the like positioned over the tank of the toilet which are not easily removable, thereby making it difficult to obtain complete and clear access to the flush valve cartridge (3).

As described in the Background section of this application, Sloan Valve Company recommends using the handles of an adjustable pair of pliers for removal and installation of their flush valve cartridges. FIG. 4 illustrates this prior art method of removing and installing a flush valve cartridge (3) in a toilet tank (1) fitted with a pressure vessel (2). Adjustable pliers (10) are shown with handle sections (11) and (11′) wedged into flush valve cartridge (3) in such a manner that the handle sections (11) and (11′) contact two of the vane-like structures (4). Once so-engaged, adjustable pliers (10) are rotated about the long axis of the adjustable pliers (10), as illustrated by arrow A. It should be noted that only a limited amount of leverage may be gained while using the adjustable pliers (10) in this manner.

One inherent problem associated with this prior art method for removal and installation of a flush valve cartridge (3) is that all the rotational force required to remove or install the flush valve cartridge (3) is concentrated on only two of the plurality of vane-like structures (4). In many instances, the rotational force required to remove a flush valve cartridge (3) from pressure vessel (2) is greater than the strength of the material used to form the vane-like structures (4), resulting in a failure (i.e., breaking) of the vane-like structures (4.) When such a failure occurs, the flush valve cartridge (3) is damaged and requires additional labor to remove.

Another problem associated with the prior art method of flush valve cartridge (3) removal and installation is that, in many instances, access space around the toilet (1) is limited and cramped, making the prior art method of removal/installation cumbersome and at times impractical. Specifically, the space above the toilet tank may be limited, making it difficult or impossible to insert the handles (11, 11′) of pliers (10) into cartridge (3). In some cases, pliers (10) can only be inserted at an angle, thereby exacerbating the problem of breaking the vane-like structures (4) as described above.

Finally, the prior art method also requires the disassembly of flush valve cartridge (3) prior to removal of the cartridge (3). Specifically, with reference to FIG. 3, actuator (6) must be removed prior to attempting the prior art method of removing flush valve cartridge (3). This additional step adds time and complexity to the removal/installation process.

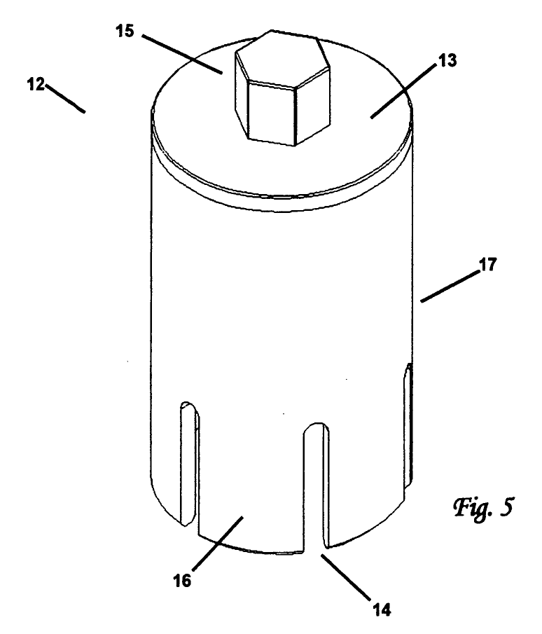

With reference to FIG. 5, one embodiment of a cartridge removal/installation tool (12) according to the invention is illustrated. Tool (12) includes a hollow body section (16), a top portion (13), a multi-sided projection (15), and a plurality of slots (14) formed through the side wall (17) of hollow body section (16). Tool (12) may be formed of any suitable material, including but not limited to polymeric materials and metals. Tool (12) may be formed by injection molding, casting, machining, or any other suitable manufacturing technique.

In the illustrated embodiment, projection (15) has six sides and resembles commonly found hex nuts. In other embodiments, projection (15) may be configured with any other suitable size and/or shape as may be desired or useful.

As is described in further detail below, slots (14) are configured to engage vane-like structures (4) of cartridge (3). In particular, the number and position of slots (14) corresponds to the number and position of vane-like structures (4) of cartridge (3), such that vane-like structures (4) are engaged by a corresponding slot (14) of tool (12). By engaging a plurality, and preferably all, of vane-like structures (4), the removal force is more evenly distributed among the vane-like structures (4), and the likelihood of breaking vane-like structures (4) is thereby reduced or eliminated. In one embodiment, each vane-like structure (4) of the cartridge (3) is engaged by a corresponding slot (14) of tool (12). In another embodiment, the number of slots (14) may exceed the number of vane-like structures (4) of the cartridge (3). In another embodiment, the number and position of slots (14) is such that tool (12) can engage cartridges (3) having differing numbers and/or positions of vane-like structures (4).

Referring now to FIG. 6, tool (12), and in particular projection (15) of tool (12), is illustrated in position to be engaged by ratchet handle (18) that has been fitted with a suitably-sized hex socket (19). When fully engaged with projection (15), hex socket (19) will be removably keyed to multi-sided projection (15), therein providing a driving connection between ratchet handle (18) and tool (12), such that tool (12) can be rotated to remove cartridge (3).

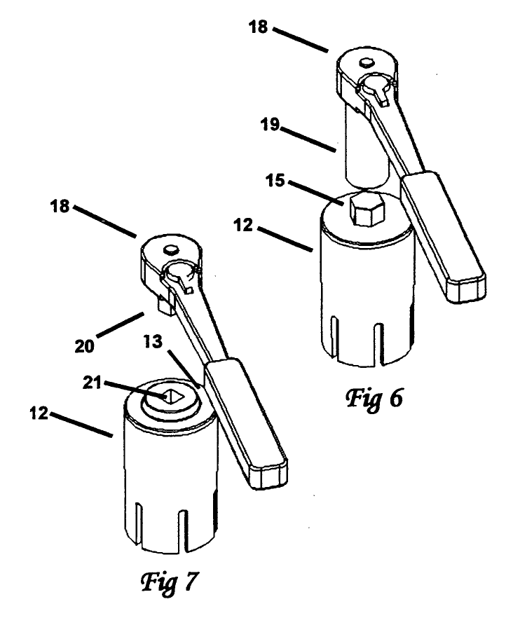

Another embodiment of tool (12) is illustrated in FIG. 7. The embodiment of FIG. 7 is similar to the embodiment of FIG. 6, except that the multi-sided projection (15) of the embodiment of FIG. 6 has been replaced with a multi-sided cavity (21) formed in top portion (13) of tool (12). Multi-sided cavity (21) is configured to receive and engage the drive key (20) of ratchet handle (18). In the illustrated embodiment, cavity (21) is a square cavity having four equal sides. As also shown in FIG. 7, ratchet handle (18) is positioned over tool (12), such that drive key 20 can engage multi-sided cavity (21) and rotatably drive tool (12). As noted above with regard to multi-sided projection (15), multisided cavity (21) may be adapted to any suitable size and/or shape.

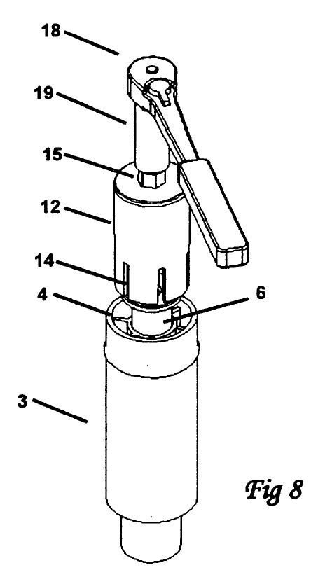

Referring now to FIG. 8, tool (12) is shown in position for engagement with the vane-like structures (4) of flush valve cartridge (3). For clarity of illustration, pressure vessel (2) has been omitted from the figure. To facilitate engagement between tool (12) and cartridge (3), slots (14) are aligned with the vane-like structures (4). Once lowered into place, the tool (12) provides secure and full engagement between all the vane-like structures (4) and slots (14). In this example six slots (14) are engaged with six vane-like structures (4). Because the present invention distributes rotational forces across a far greater surface area prevents unwanted breakage of the vane-like structures (4) when compared to the prior art method.

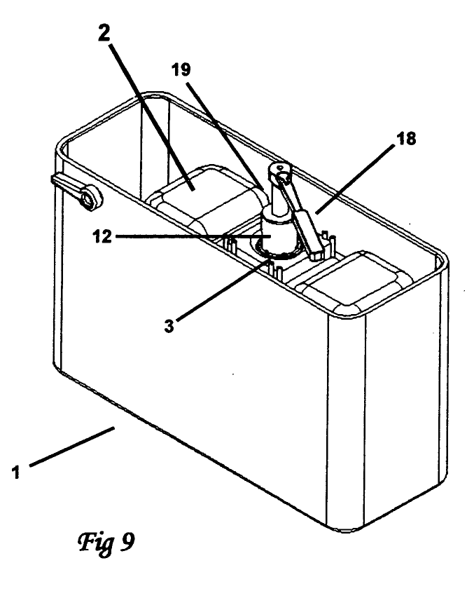

FIG. 9 illustrates toilet tank (1) fitted with pressure vessel (2) and flush valve cartridge (3). Also shown are ratchet handle (18) and hex socket (19). The tool (12) is fully engaged with flush valve cartridge (3). As can be seen, the length of ratchet handle (18) provides far greater rotational leverage when compared with the prior art method using pliers (10). Additionally, the low profile of tool (12) and ratchet handle (18) allows the user to work more conveniently in the tight confines where the work must be preformed.

Although specific embodiments have been illustrated and described herein, it will be appreciated by those of ordinary skill in the art that a variety of alternate and/or equivalent implementations may be substituted for the specific embodiments shown and described without departing from the scope of the present invention. This application is intended to cover any adaptations or variations of the specific embodiments discussed herein. Therefore, it is intended that this invention be limited only by the claims and the equivalents thereof.

What is claimed is:

1. A plumbing tool for the removal and installation of a flush valve cartridge of the type having a plurality of vane-like structures, the tool comprising:
a hollow longitudinal body having side walls, a closed end and an open end;
an drive engagement means positioned at the closed end of the longitudinal body;
a plurality of longitudinal slots extending through the sidewalls at the open end of the longitudinal body, wherein the slots extend from the open end of the longitudinal body and terminate a distance from the open end, the slots configured and positioned for engagement with the plurality of vane-like structures of the flush valve cartridge.

2. The tool according to claim 1, wherein the drive-engagement means comprises a multi-sided protrusion extending from the closed end of the body.

3. The tool according to claim 2, wherein the multi-sided protrusion is comprised of six equal sides.

4. The tool according to claim 1, wherein the drive-engagement means comprises a multi-sided cavity extending into the closed end of the body.

5. The tool according to claim 4, wherein the multi-sided cavity is comprised of four equal sides.

6. The tool according to claim 1, wherein the longitudinal body is formed from a polymeric material.

7. The tool according to claim 1, wherein the longitudinal body is formed from a metal.
